(19) United States
(12) Patent Application Publication
(10) Pub. No.: US 2023/0304175 A1
(43) Pub. Date: Sep. 28, 2023

(54) CATALYST FOR AN ELECTROCHEMICAL CELL, AND METHODS OF MAKING AND USING THE CATALYST

(71) Applicant: The Research Foundation for the State University of New York, Albany, NY (US)

(72) Inventors: Chuan-Jian Zhong, Endwell, NY (US); Shan Wang, Beaverton, OR (US)

(21) Appl. No.: 18/102,391

(22) Filed: Jan. 27, 2023

Related U.S. Application Data
(60) Provisional application No. 63/324,338, filed on Mar. 28, 2022.

(51) Int. Cl. C25B 11/095; C25B 1/04; C25B 11/037; C25B 11/065

(52) U.S. Cl. CPC C25B 11/095; C25B 1/04; C25B 11/037; C25B 11/065

(57) ABSTRACT

The present disclosure relates to a method of making one or more PAA-coated silver nanoparticles, including: heating an aqueous solution including a silver source material such as silver nitrate, a reducing agent such as monoethanolamine, and a capping molecule such as PAA under conditions suitable for forming a reaction mixture; and contacting the reaction mixture with an antisolvent to form one or more PAA-coated silver nanoparticles. In embodiments, the present disclosure includes a cathode catalyst, including: one or more substantially monodisperse PAA-coated silver nanoparticles, as well as cathodes and electrochemical cells including the PAA-coated silver nanoparticles.

### CROSS REFERENCE TO RELATED APPLICATIONS

The present application claims the benefit of prior-filed U.S. Provisional Application Ser. No. 63/324,338, which was filed on Mar. 28, 2022, the disclosure of which is hereby incorporated by reference.

### STATEMENT OF GOVERNMENTAL SUPPORT

This invention was made with governmental support under grant no. CHE1566283 and CHE2102482 awarded by The National Science Foundation. The government has certain rights in this invention.

### FIELD OF THE INVENTION

This disclosure generally relates to an electrode catalyst and formulations thereof, an electrode including the electrode catalyst, an electrochemical cell including the electrode and electrode catalyst, as well as manufacturing methods for nano-engineering silver catalysts. The invention further relates to an electrode including a substrate having an electrically conductive surface including one or more nano-engineered silver catalysts suitable for use in electrolytic water splitting to produce pure hydrogen.

### BACKGROUND

As a promising substitute for fossil fuels, hydrogen has emerged as a clean and renewable energy. A key challenge is the efficient production of hydrogen to meet the commercial-scale demand of hydrogen. Water splitting electrolysis is a promising pathway to achieve the efficient hydrogen production in terms of energy conversion and storage in which catalysis or electrocatalysis plays a critical role. The development of active, stable, and low-cost catalysts or electrocatalysts is an essential prerequisite for achieving the desired electrocatalytic hydrogen production from water splitting for practical use. Generally, the overall reaction of water electrolysis can be divided into two half-cell reactions: hydrogen evolution reaction (HER) and oxygen evolution reaction (OER). HER is the reaction where water is reduced at the cathode to produce H₂, and OER is the reaction where water is oxidized at the anode to produce O₂. One of the critical barriers that keep water splitting from being of practical use is the sluggish reaction kinetics of OER and HER due to high overpotentials, a measure of the kinetic energy barriers. Therefore, catalysis plays a major role in both OER and HER. Highly effective catalysts are needed to minimize the overpotentials for OER and HER towards efficient H₂ and O₂ production (see e.g., S. Wang, A. Lu, C. J. Zhong, Hydrogen Production from Water Electrolysis: Role of Catalysts, Nano Convergence, 2021, 8, 4).

There are two main types of HER electrocatalyst: noble-metal based electrocatalysts and non-noble metal based electrocatalysts. For the noble-metal based electrocatalyst, especially platinum (Pt)-based catalysts, several strategies are being developed to increase HER performance and lower the electrocatalyst price. For example, alloying Pt with other low-cost transition metal which could improve Pt utilization and the synergistic effect of alloy could modify the electronic environments to improve the activity. Also, coupling Pt with other water dissociation promoters is an important strategy to improve the alkaline HER activities which is very meaningful for industry practical use. For non-noble metal based HER electrocatalysts, a great deal of attention has been drawn to the development of non-noble metal-based catalysts largely with low-cost and earth-abundant characteristics.

Recently, silver has received attention as a catalyst for HER. Among various metal, silver (Ag) is the most abundant and least expensive noble metal with the highest electrical conductivity. Nevertheless, silver problematically shows very weak hydrogen adsorption energy and poor HER activity due to the d10 electronic structure. Therefore, many efforts have been devoted to regulating pure Ag, including increasing its surface area, creating more unsaturated coordination atoms and introducing tensile stress to cause upshift of the d-band center, so that the HER performance of Ag can approach or exceed that of commercial Pt and make Ag a potential alternative for Pt. There remains a continuous need for silver (Ag) including formulations for high HER performance in water-splitting hydrogen production.

Prior-art-of-interest includes Wang, S., Lu, A. & Zhong, C J. Hydrogen production from water electrolysis: role of catalysts. Nano Convergence 8, 4 (2021); U.S. Pat. No. 5,716,437 entitled Materials for use in electrode manufacture; and U.S. Pat. No. 10,519,554 entitled Water splitting method and system (all of which are herein entirely incorporated by reference). However, none of these references provide the nano-engineered catalyst of the present disclosure.

There is a continuous need for electrocatalysts for the hydrogen evolution reaction (HER), and methods of making and tuning such electrocatalysts. There also remains a need for improving the water splitting based hydrogen production and eliminating a need for over-potential application.

### SUMMARY

The present disclosure provides an electrode material suitable for use as a catalyst in electrolytic water splitting to produce pure hydrogen, and methods of making the electrode material and formulations thereof.

In embodiments, the present disclosure includes an electrode material for hydrogen evolution reaction, including: a plurality of ultra-small polyacrylic acid (PAA) coated silver nanoparticles. In embodiments, the plurality of ultra-small PAA coated silver nanoparticles have an average longest diameter of about 1.0-30 nm, or about 1.0-10 nm.

In embodiments, the present disclosure includes an electrode for hydrogen evolution reaction formed by a substrate and the electrode material of the present disclosure, wherein the electrode material is provided as a coating on the substrate.

In embodiments, the present disclosure includes a system such as an electrochemical cell for water electrolysis including an anode and a cathode, wherein the cathode is the electrode of the present disclosure.

In embodiments, the present disclosure includes a method of making a plurality of ultra-small polyacrylic acid (PAA) coated silver nanoparticles, including: heating an aqueous solution including a silver source material, a reducing agent, and a capping molecule under conditions suitable for forming a reaction mixture; and contacting the reaction mixture with an effective amount of antisolvent to form one or more PAA-coated silver nanoparticles. In embodiments, the silver source material is a silver salt such as silver nitrate. In embodiments, the silver source material is silver nitrate (AgNO₃), the reducing agent is monoethanolamine (MEA) and the capping agent is polyacrylic acid (PAA).

In embodiments, the present disclosure includes a method of making an electrode, including: contacting a substrate with a formulation including an electrode material including a plurality of polyacrylic acid (PAA) coated silver nanoparticles in a hydrogen atmosphere; and heating the formulation atop the substrate to a temperature of 150 to 700 degrees Celsius for a duration sufficient to form an electrode for hydrogen evolution reaction, wherein the electrode material is provided as a coating on the substrate.

In embodiments, the present disclosure includes a conductive electrode paste or ink composition, including: an electrode material including a plurality of polyacrylic acid (PAA) coated silver nanoparticles. In embodiments, the conductive electrode paste or ink composition, further includes a mixture of deionized water and ethylene glycol. In embodiments, the conductive electrode paste or ink is applied to a substrate in a hydrogen (H₂) environment.

### BRIEF DESCRIPTION OF THE DRAWINGS

Embodiments of the present disclosure, briefly summarized above and discussed in greater detail below, can be understood by reference to the illustrative embodiments of the disclosure depicted in the appended drawings. However, the appended drawings illustrate only typical embodiments of the disclosure and are therefore not to be considered limiting of scope, for the disclosure may admit to other equally effective embodiments.

FIGS. 1A-1D depict TEM characterization of lab-synthesized silver (Ag) particles.

FIGS. 1E-1F depict commercial silver (Ag) nano ink such as commercial silver (Ag) paste (e.g., NovaCentrix's silver paste).

FIGS. 2A, 2B and 2C depict an XRD characterization of 200-degree Celsius H₂ treated silver (Ag) paste (FIG. 2A), 400 degrees Celsius hydrogen (H₂) treated silver (Ag) paste (FIG. 2B), and a comparison of the XRD patterns between 200° C. H₂ treated Ag paste and 400° C. H₂ treated Ag paste (FIG. 2C).

FIG. 2D depicts a comparison of (111) peak in the XRD patterns between 200° C. H₂ treated Ag paste and 400° C. H₂ treated Ag paste.

FIG. 3A depicts HER polarization curves of: (a) 400° C. hydrogen (H₂) treated silver (Ag) paste on carbon; (b) platinum (Pt) bulk; (c) 200° C. hydrogen (H₂) treated silver (Ag) paste on carbon (C); (d) silver (Ag) bulk; (e) carbon (C) in nitrogen N₂ and saturated 0.5 M H₂SO₄ solution with a scan rate 10 my/s.

FIG. 3B depicts HER polarization curves of: PAA-coated silver nanoparticles of the present disclosure heated to various temperatures.

FIG. 4 depicts a nanoparticle of the present disclosure.

FIGS. 5A and 5B depict, respectively, an ink formulation and paste formulation suitable for use in accordance with the present disclosure.

FIG. 6 depicts an electrode for HER reaction according to an embodiment.

FIGS. 7A and 7B depict an electrochemical cell of the present disclosure suitable for splitting water in accordance with the present disclosure.

Embodiments of the present disclosure, briefly summarized above and discussed in greater detail below, can be understood by reference to the illustrative embodiments of the disclosure depicted in the appended drawings. However, the appended drawings illustrate only typical embodiments of the disclosure and are therefore not to be considered limiting of scope, for the disclosure may admit to other equally effective embodiments.

### DETAILED DESCRIPTION

The present disclosure provides an electrode material such as an electrode catalyst and formulations thereof, an electrode including the electrode material, an electrochemical cell including the electrode and electrode material, as well as manufacturing methods for nano-engineering silver catalysts.

Embodiments of the present disclosure advantageously eliminate or at least significantly reducing the over-potential required for water splitting thus for hydrogen production from water. Advantages also include providing ultra-small, monodisperse, highly efficient electrocatalysts suitable for use in the hydrogen evolution reaction (HER) in an electrolyte medium such as acidic media. Additional advantages include providing low-cost alternative HER electrocatalysts with high activity and stability which help overcome or alleviate a problematic overpotential in water splitting.

### Definitions

As used in the present specification, the following words and phrases are generally intended to have the meanings as set forth below, except to the extent that the context in which they are used indicates otherwise.

As used herein, the singular forms “a”, “an”, and “the” include plural references unless the context clearly dictates otherwise. Thus, for example, references to “a compound” include the use of one or more compound(s). “A step” of a method means at least one step, and it could be one, two, three, four, five or even more method steps.

As used herein the terms “about,” “approximately,” and the like, when used in connection with a numerical variable, generally refers to the value of the variable and to all values of the variable that are within the experimental error (e.g., within the 95% confidence interval [CI 95%] for the mean) or within ±10% of the indicated value, whichever is greater.

As used herein the term “catalyst” refers to one or more materials that may be of use in the conversion of one or more other materials.

As used herein, the term “forming a mixture” refers to the process of bringing into contact at least two distinct species such that they mix together and interact. “Forming a reaction mixture” and “contacting” refer to the process of bringing into contact at least two distinct species such that they mix together and can react, either modifying one of the initial reactants or forming a third, distinct, species, a product. It should be appreciated, however, the resulting reaction product can be produced directly from a reaction between the added reagents or from an intermediate from one or more of the added reagents which can be produced in the reaction mixture. “Conversion” and “converting” refer to a process including one or more steps wherein a species is transformed into a distinct product.

The term “recovering” refers to separating a chemical compound from an initial mixture to obtain the compound in greater purity or at a higher concentration than the purity or concentration of the compound in the initial mixture.

The term “substantially purified” as used herein, refers to a component of interest that may be substantially or essentially free of other components which normally accompany or interact with the component of interest prior to purification. By way of example only, a component of interest may be “substantially purified” when the preparation of the component of interest contains less than about 10%, less than about 5%, less than about 4%, less than about 3%, less than about 2%, or less than about 1% (by dry weight) of contaminating components. Thus, a “substantially purified” component of interest may have a purity level of about 70%, about 75%, about 80%, about 85%, about 90%, about 95%, about 96%, about 97%, about 98%, about 99% or greater.

These definitions are intended to supplement and illustrate, not preclude, the definitions that would be apparent to one of ordinary skill in the art upon review of the present disclosure. Before embodiments are further described, it is to be understood that this disclosure is not limited to particular embodiments described, as such may, of course, vary. It is also to be understood that the terminology used herein is for the purpose of describing particular embodiments only and is not intended to be limiting.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges, and are also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described. All publications mentioned herein are incorporated herein by reference to disclose and describe the methods and/or materials in connection with which the publications are cited.

### Description of Certain Embodiments of the Present Disclosure

In embodiments, the present disclosure includes an electrode material for hydrogen evolution reaction, including: a plurality of ultra-small polyacrylic acid (PAA) coated silver nanoparticles. In embodiments, the plurality of ultra-small PAA coated silver nanoparticles have an average longest diameter of about 1.0-30 nm, about 1.0-20 nm, or below 10 nm. In embodiments, the plurality of PAA coated silver nanoparticles are characterized as substantially mono-disperse nanoparticles having an average longest diameter of about 1-10 nm. In embodiments, the plurality of polyacrylic acid (PAA) coated silver nanoparticles are characterized as highly efficient electrocatalysts toward hydrogen evolution reaction in a water splitting reaction. In embodiments, the plurality of PAA coated silver nanoparticles are substantially purified. In embodiments, the plurality of PAA coated silver nanoparticles are round or substantially spherical. In embodiments, the electrode material includes a plurality of particles including an altered crystal structure featuring a lower surface atomic coordination number, a lattice strain of about 0.5% to about 1%, and combinations thereof.

In embodiments, a process is provided for preparing monodisperse silver nanoparticles in high product concentration, and high recovery. In embodiments, the process includes the following steps: preparing and heating a homogeneous silver complex solution including a reducing agent and capping agent, wherein the reducing agent is added in an amount sufficient to form silver nanoparticles, and wherein capping agent is provided in an amount sufficient to modify the silver nanoparticle surfaces; adding precipitating agent to the homogeneous solution or to form a slurry; and optionally, washing and recovering the silver nanoparticles by phase extraction or centrifuge.

In embodiments, the silver complex solution includes the reducing agent and the capping agent in one-pot, wherein antisolvent is added to precipitate the nanoparticles. In embodiments, the size of the synthesized monodispersed silver nanoparticles are considered in the nanometer range or finer, specifically ranging from 1 nm to 50 nm, and in particular from 1 nm to 30 nm, 1 nm to 20 nm, or less than 10 nm. In embodiments, the silver nanoparticles are oxidation resistant and can be dispersed in either polar or nonpolar solvent. In embodiments, the size of nanoparticles are predetermined and controlled by antisolvent selection and the relative concentration of silver source in the reaction mixture.

In embodiments, a plurality of PAA coated silver nanoparticles, such as ultra-small polyacrylic acid (PAA) coated silver nanoparticles are formed by heating an aqueous solution including a silver source material, a reducing agent, and a capping molecule under conditions suitable for forming a reaction mixture for forming a plurality of PAA coated silver nanoparticles; and contacting the reaction mixture with an effective amount of antisolvent to form one or more PAA-coated silver nanoparticles in a slurry. In embodiments, the silver source material is a silver salt such as silver nitrate. In embodiments, the reducing agent is ethanolamine. In embodiments, the silver source material is silver nitrate (AgNO₃), the reducing agent is monoethanolamine (MEA) and the capping agent is polyacrylic acid (PAA). In embodiments, the antisolvent is ethanol. In embodiments, the heating is to a temperature of about 90 degrees Celsius for a first duration in an air atmosphere.

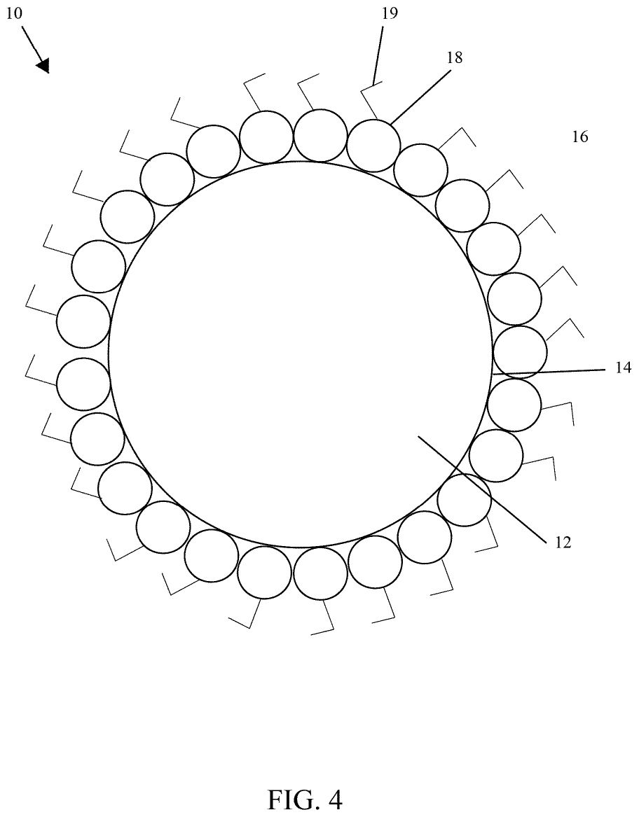

Referring now to FIG. 4, a nanoparticle 10 of the present disclosure is shown. Here, nanoparticle 10 includes a metal core 12 including an outer surface 14. In embodiments, metal core is spherical or substantially spherical. Capping agent 16 is shown disposed upon outer surface 14. Still referring to FIG. 4, capping agent such as PAA includes a hydrophilic head 18 adjacent to and in contact with outer surface 14, and a hydrophobic tail 19 positioned away from the outer surface 14. In embodiments, capping agent 16 is PAA.

In embodiments, the present disclosure includes a cathode catalyst, including: one or more substantially monodisperse PAA-coated silver nanoparticles. In embodiments, the one or more substantially monodisperse PAA-coated silver nanoparticles are substantially purified and/or isolated.

Embodiments of the present disclosure provide methods of making ultra-small, monodisperse, polyacrylic acid (PAA) coated silver nanoparticle electrocatalyst, and highly efficient pastes, cathodes and electrochemical cells including them. For example, in embodiments, the present disclosure includes a fully aqueous mono-phase system to synthesize PAA-coated silver nanoparticles in the size range of 5-30 nm, with the majority of the particles measuring less than 10 nm. In embodiments, the PAA-coated silver nanoparticles of the present disclosure exhibit excellent electrocatalytic activity and stability towards HER in an electrochemical cell.

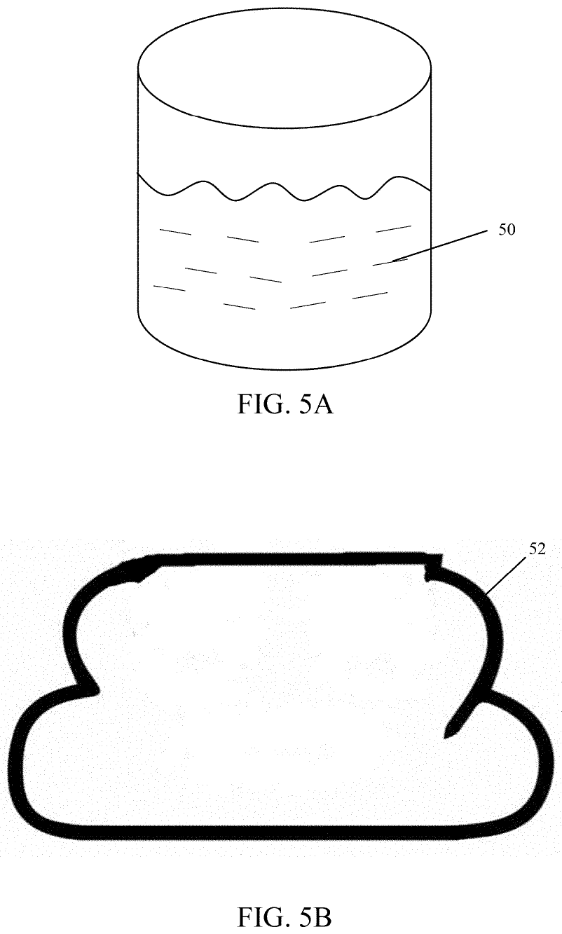

In embodiments, the nanoparticles of the present disclosure may be further formulated to form a conductive ink 50 or paste 52 as shown in FIGS. 5A and 5B respectively. In embodiments, the present disclosure includes preparing a conductive formulation such as an ink or paste, in which the mixture includes 1 to 90 wt %, or 1 to 30 wt % of silver nanoparticles of the total formulation. In embodiments, a conductive ink or paste including nanoparticles as fillers are provided. This use of nanoparticles allows the ink or paste to be disposed atop a substrate at a temperature (e.g., 120 degrees C.-700 degrees C., or 120 degrees C.-500 degrees C.) under hydrogen. In embodiments, once the nanoparticles of the present disclosure are formed that may be added to commercial pastes or formed into inks and pastes by the addition of fillers and/or solvents in an amount effective to form an ink or paste. In embodiments, a conductive paste may be formed to have a predetermined viscosity such as between 50 cP to 500,000 cP, and in particular from 100,000 to 300,000 cP, for application to a substrate. In embodiments, ink or paste formulation can be applied to a substrate by a thermal deposition process under hydrogen. By maintaining a hydrogen atmosphere, oxidation of the top surface of the substrate is avoided. In embodiments, the ink or paste may be deposited or printed atop or directly atop various substrates to form an electrode.

In embodiments, the present disclosure further includes an electrode including a substrate having an electrically conductive surface including one or more nano-engineered silver catalysts suitable for use in electrolytic water splitting to produce pure hydrogen. In embodiments, the electrode material or catalyst of the present disclosure is disposed directly atop a substrate such as a cathode and forms a coating thereon. In embodiments, the coating is characterized as a continuous coating atop and around the substrate. In some embodiments, the substrate is made of a material suitable for use as a cathode in an electrochemical cell. In some embodiments, the substrate may be a refractive material, a carbon substrate, a ceramic substrate, a honeycomb structure, a metallic substrate, a ceramic foam, a metallic foam, a reticulated foam, or suitable combinations, where the substrate has a plurality of channels and a porosity. In embodiments, substrates are either carbon, metallic, or ceramic, and provide a three-dimensional support structure. In embodiments, the support includes or consists of active carbon.

In embodiments, the electrode material described herein are deposited on a substrate material. In embodiments the electrode material is provided in an amount sufficient to coat, substantially coat, or partially coat an electrode such as a cathode. For example, in embodiments, an electrode material may be 0.1 to 20 percent weight of the total electrode. In embodiments, the electrode material is affixed to a substrate to produce an electrode such as an electrode suitable for use in an electrochemical cell. In embodiments, percent weight includes the percent weight of the total electrode. In embodiments, one or more electrode materials of the present disclosure is combined with a carbon component. In embodiments, a carbon component can be impregnated or coated with the electrode material of the present disclosure. In yet another embodiment, a substrate may be zone-coated with electrode material in a first region and no electrode material in a different electrode material-free region. In embodiments, a plurality of ultra-small polyacrylic acid (PAA) coated silver nanoparticles are disposed directly atop cathode material suitable for use in an electrochemical cell. In embodiments, the coating is a continuous coating in that a uniform layer of a plurality of ultra-small polyacrylic acid (PAA) coated silver nanoparticle catalysts of the present disclosure is disposed all around the substrate. In embodiments, a plurality of ultra-small polyacrylic acid (PAA) coated silver nanoparticle (catalyst) is coated atop a substrate at a thickness suitable for coating the substrate.

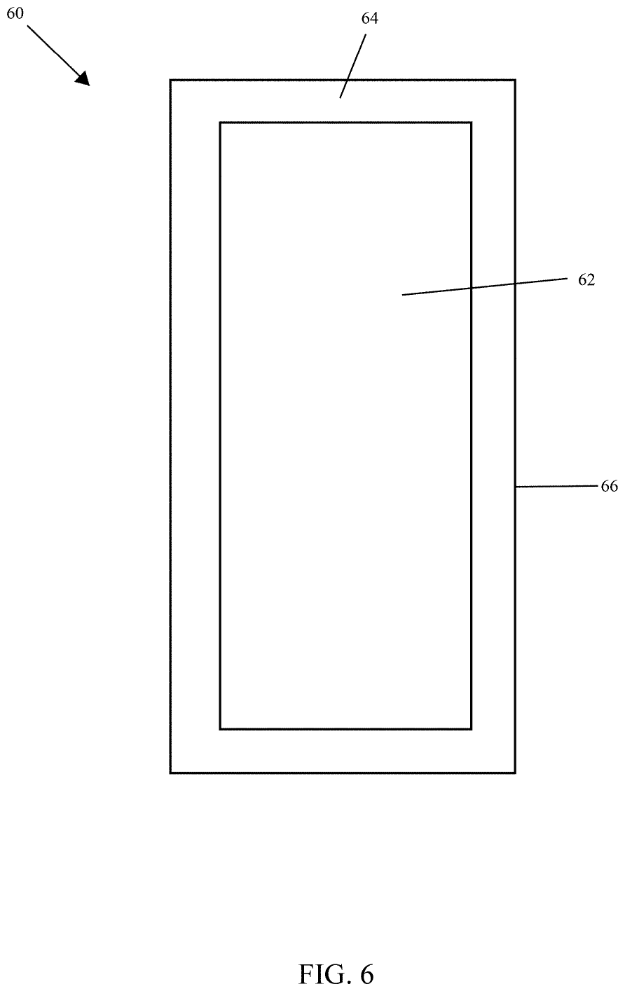

In embodiments, the present disclosure includes an electrode for hydrogen evolution reaction including a substrate and the electrode material of the present disclosure, wherein the electrode material is provided as a coating on the substrate. In embodiments, the electrode is a cathode disposed within an electrochemical cell including an acidic electrolyte. In embodiments, the substrate is carbon. Referring now to FIG. 6, an electrode 60 for HER reaction is shown. Here, electrode material 64 is shown deposited atop substrate 62. In FIG. 6 an electrode 60 for HER is formed by a substrate 62 and an electrode material 64 according to an embodiment, where the electrode material 64 is provided as a coating 66 on the substrate 62 is schematically represented. In embodiments, the substrate may be composed of carbon. With substrate 62, the coating 66 of electrode material 64 may be present atop or directly atop of the substrate and, optionally form a continuous layer thereon.

In some embodiments, the present disclosure includes a cathode for an electrochemical cell, including: a PAA-coated silver nanoparticle catalyst embodiment of the present disclosure. In embodiments, the catalyst is disposed directly atop the cathode, and forms a coating thereon. In embodiments, the coating is characterized as a continuous coating atop and around the electrode.

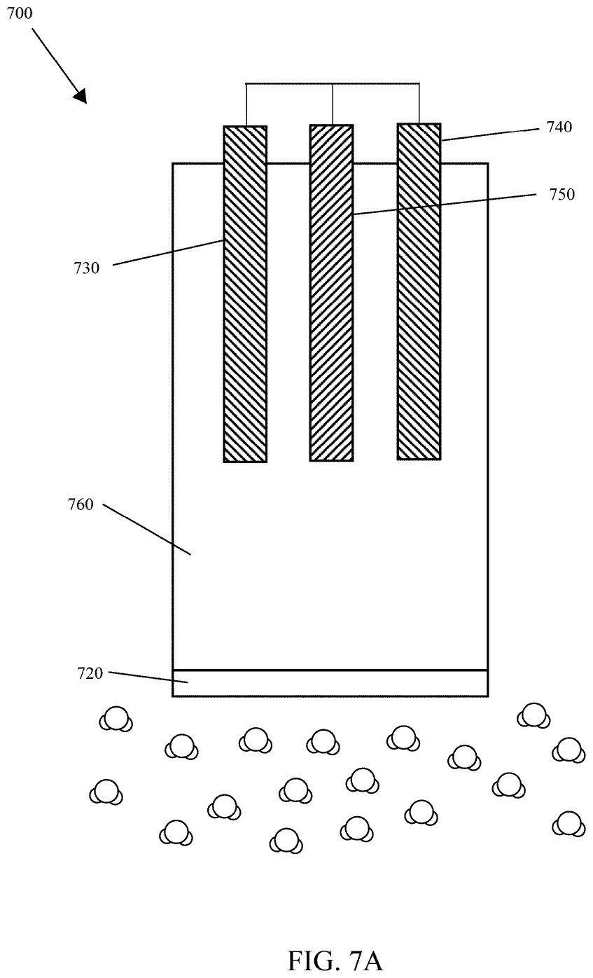

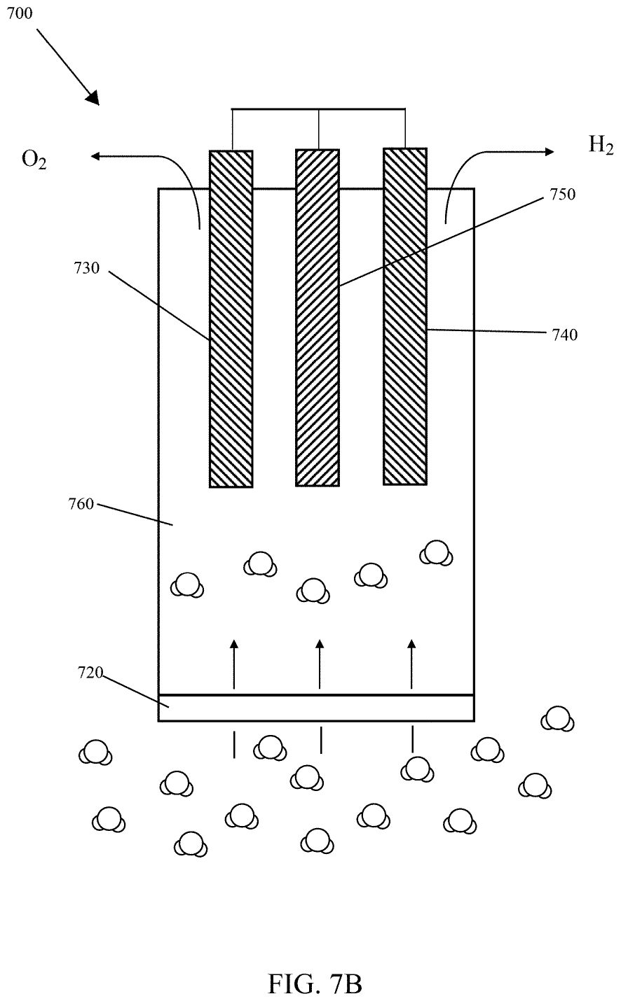

In embodiments, the present disclosure includes an electrochemical cell, including: a cathode embodiment of the present disclosure, such as a cathode including the catalyst of the present disclosure. Generally, the overall reaction of water electrolysis can be divided into two half-cell reactions: hydrogen evolution reaction (HER) and oxygen evolution reaction (OER). HER is the reaction where water is reduced at the cathode to produce H₂, and OER is the reaction where water is oxidized at the anode to produce O₂. FIGS. 7A and 7B depict an electrochemical cell of the present disclosure suitable for splitting water in accordance with the present disclosure. As shown herein electrochemical cell system 700 includes a semipermeable membrane 720, a first electrode (an anode) 730, a second electrode (a cathode) 740, and optionally a third reference electrode 750. In addition, the electrochemical cell 700 may include a cover portion (not shown) having inlets/outlets, and in which the first electrode 730 and the second electrode 740 in addition to the semipermeable membrane 720 are disposed.

In embodiments, the electrochemical cell 700 according to an embodiment may be include an alkaline or acidic inner electrolyte 760 but is not limited thereto. In embodiments, the first electrode 730 and the second electrode 740 in addition to the electrolyte membrane 720 may form a single unit cell.

In embodiments, within electrochemical cell 700, an electrochemical reaction may be carried out in as illustrated in FIG. 7B. In embodiments, hydrogen may be generated at second electrode (a cathode) 740. In this case, water is split to produce hydrogen. In embodiments second electrode (a cathode) 740 is characterized as a HER cathode. In embodiments, first electrode 730 (an anode) is characterized as an OER anode, wherein oxygen is generated.

In embodiments the first electrode 730 and the second electrode 740 may be include a conductive material. In embodiments, at least one side of the second electrode 740 may be coated with electrode material of the present disclosure including an exemplary embodiment as HER catalyst of the present disclosure.

In embodiments, the semipermeable membrane 720 may have the form of a membrane, and may allow water to continuously flow and replace inner electrolyte depleted by the reaction of the present disclosure. In embodiments, the electrolyte membrane 720 is disposed within an electrolyte such as an alkaline electrolyte solution or acidic electrolyte solution. In embodiments, the electrolyte solution is acidic electrolyte solution.

In embodiments, the present disclosure includes a system for water electrolysis including an anode and a cathode, wherein the cathode is the electrode of the present disclosure.

### Example I

A novel approach to engineering the lattice strain of silver nanomaterials. The preparation of the nano-engineered silver catalyst involves a combination of nanopaste formulation and thermochemical treatment towards the preparation of the silver catalysts for high HER performance in water-splitting hydrogen production.

### Technical Details

### Synthesis of PAA-Coated Silver NPs

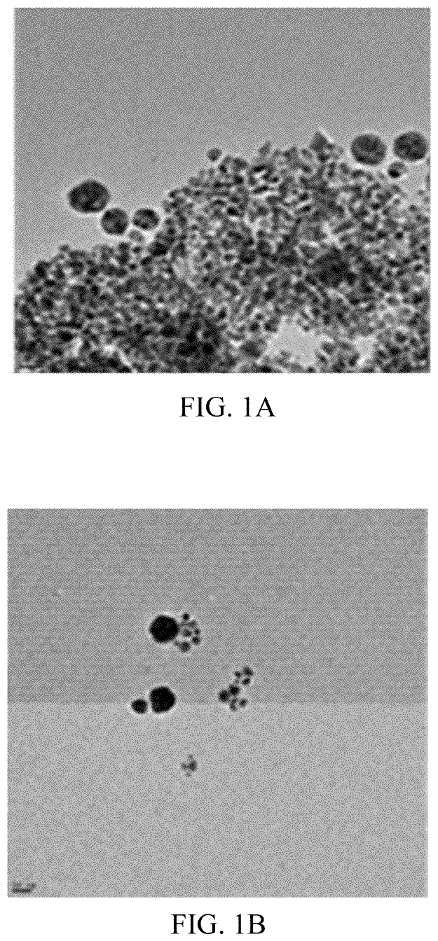

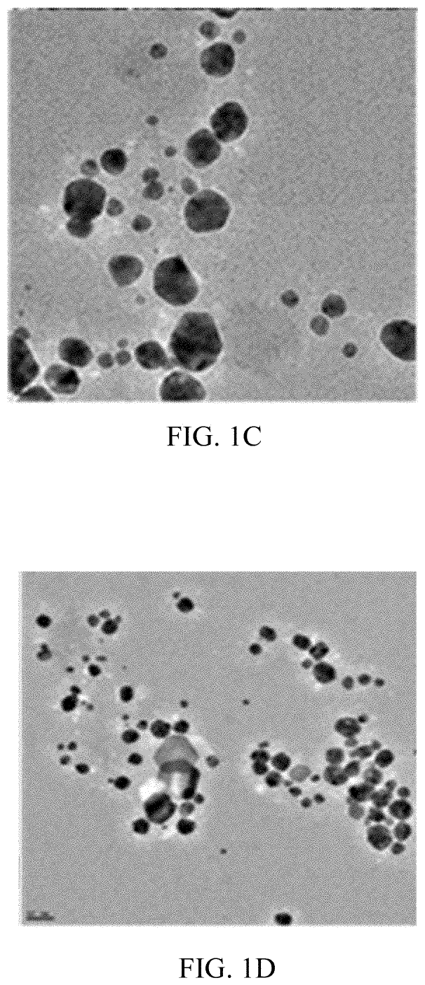

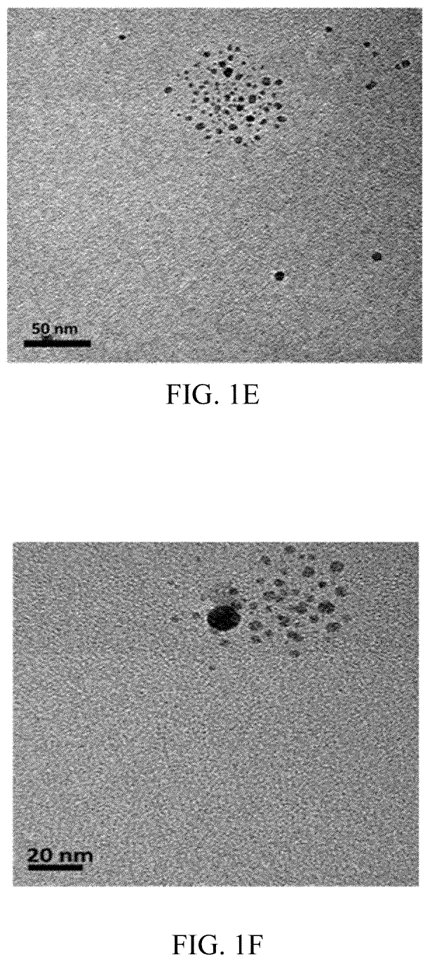

In embodiments, the present disclosure includes a fully aqueous mono-phase system including silver nitrate as the silver source, monoethanolamine (MEA) as a reducing reagent, PAA as a capping molecule and deionized water as the medium. In embodiments, MEA, PAA and AgNO₃ were sequentially dissolved in 60 ml deionized water, under vigorous magnetic stirring at room temperature for 1 h until a yellowish and transparent solution was obtained. Subsequently, the mixture was heated to 65 degrees Celsius with continuous stirring for 1 h. The color of the mixture was observed to vary in the following sequence: yellowish, brown, orange, and dark red. After completion of the reaction, the mixture was precipitated by the addition of 300 ml ethanol. PAA-coated silver nanoparticles, which are formed as black precipitates. Referring to FIGS. 1A and 1B, TEM images of PAA-coated silver nanoparticles of the present disclosure are shown. The TEM image of the sample shows that the silver nanoparticle size in the range of 5-30 nm, with the majority of the particles measuring less than 10 nm.

### Preparation of Silver NP Inks

Silver NP inks with certain solid contents were prepared by adding silver nanoparticle powder to a mixture of deionized water and ethylene glycol. Ethylene glycol was used to adjust the inks' viscosity and surface tension. Commercial silver pastes were also used for the formulation of the silver paste, which involves aquatic chronic and methoxypropoxy additives.

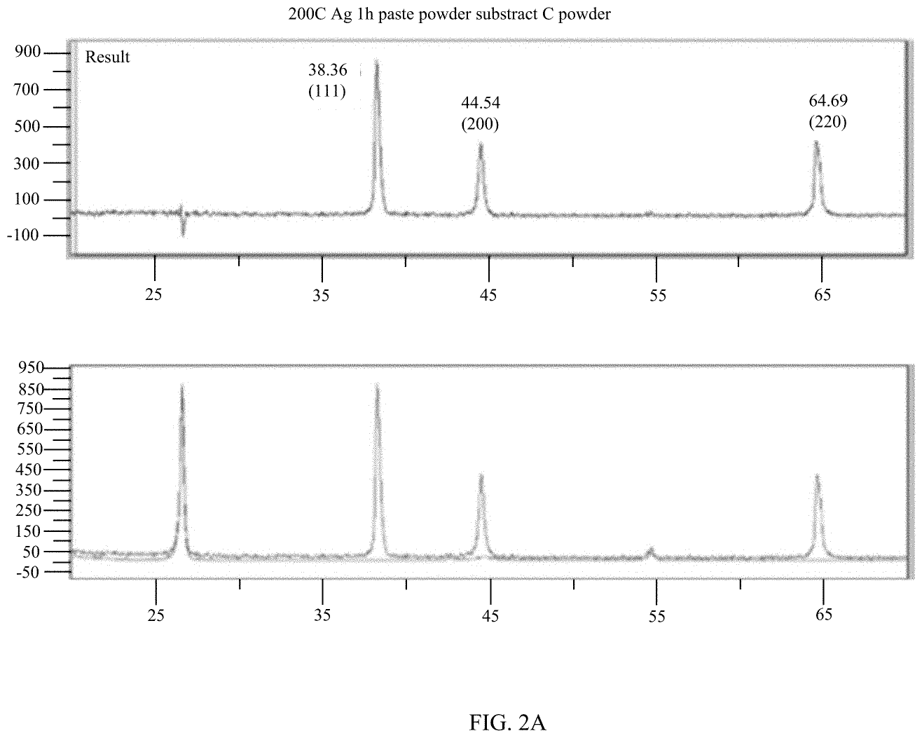

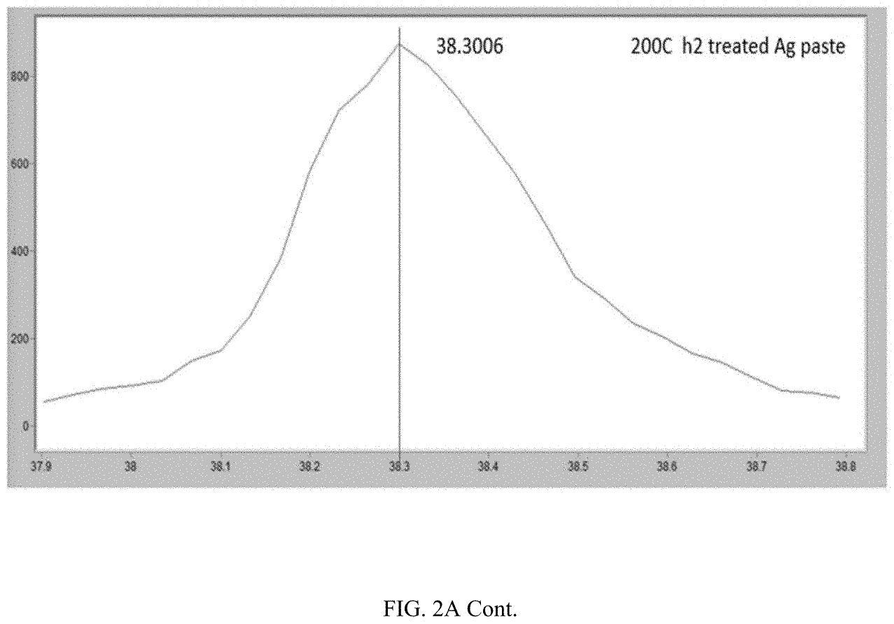

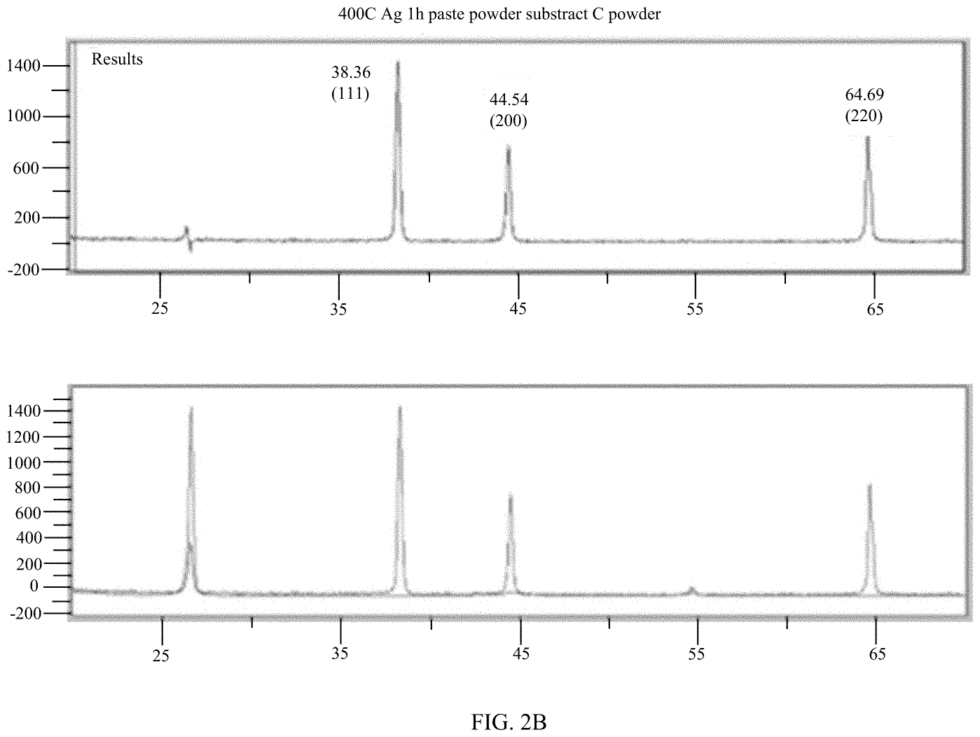

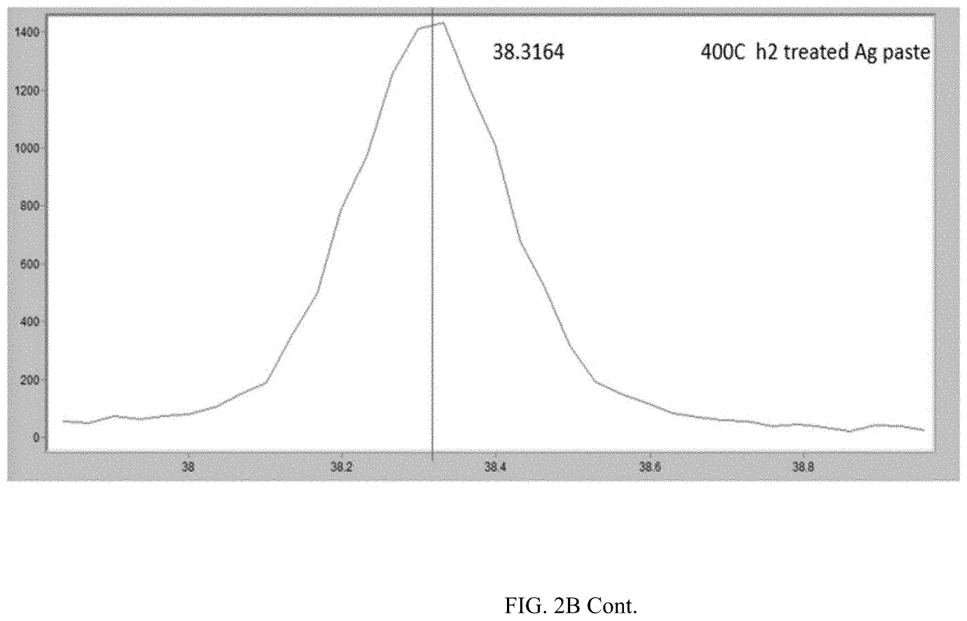

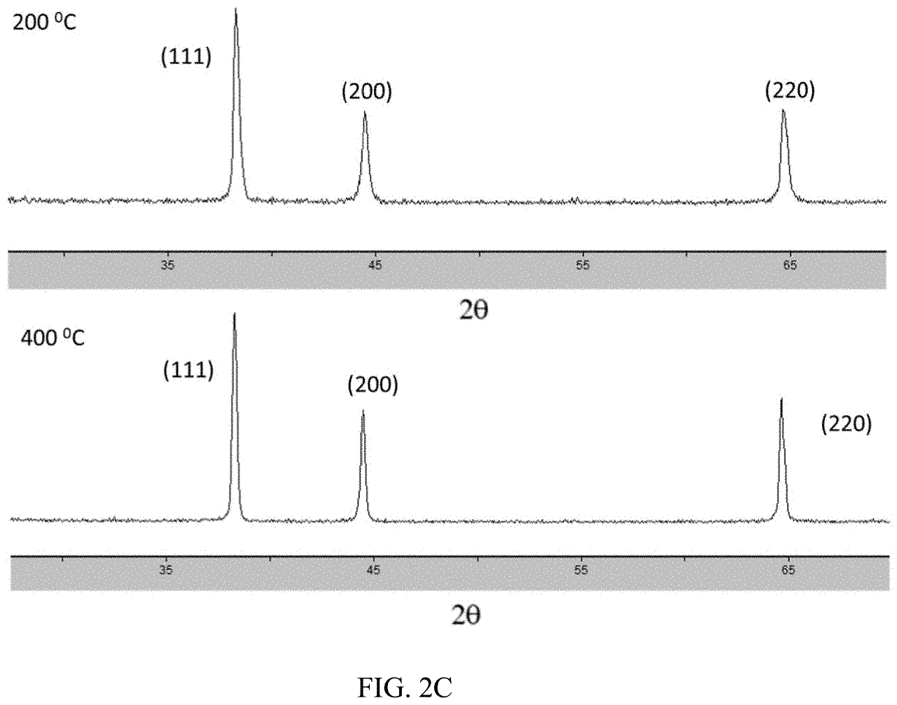

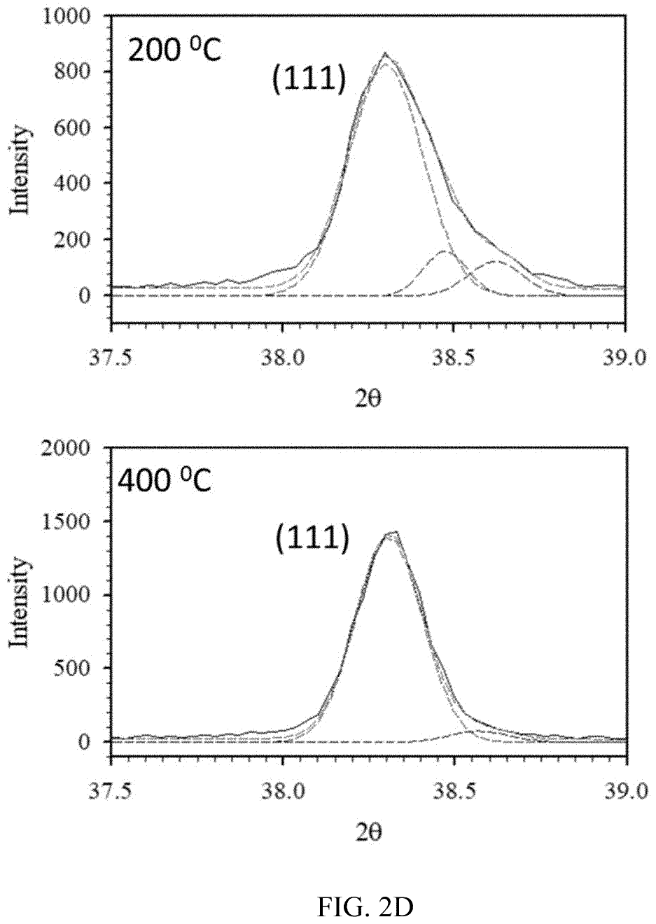

Referring now to FIGS. 2A, 2B, and 2C a comparison is shown between XRD feature of the 200-degree Celsius hydrogen (H₂) treated silver (Ag) paste and the 400 degrees Celsius hydrogen (H₂) treated silver (Ag) paste. The peak shift is indicative of the lattice space d or the lattice constant. In comparison with the lattice parameter of bulk silver (4.09 nm), the lattice constant for the 200 degrees Celsius treated silver (Ag) is 4.07 nm, whereas that for the 400 degrees Celsius treated silver (Ag) paste is 4.06 nm, showing a decrease of the lattice constant with the temperature. Both are smaller than that for bulk silver (Ag), indicative of lattice strain.

More specifically, FIGS. 2A, 2B and 2C depict an XRD characterization of 200-degree Celsius H₂ treated silver (Ag) paste (FIG. 2A), 400 degrees Celsius hydrogen (H₂) treated silver (Ag) paste (FIG. 2B), and a comparison of the XRD patterns between 200° C. H₂ treated Ag paste and 400° C. H₂ treated Ag paste (FIG. 2C). FIG. 2D depicts a comparison of (111) peak in the XRD patterns between 200° C. H₂ treated Ag paste and 400° C. H₂ treated Ag paste.

The overall peak position for the 400° C. sample is in fact smaller than the overall peak position of the 200° C. sample based on the broadening portion of the larger 2θ side for the former. By peak deconvolution, it is clear that the 200° C. sample's (111) peak has more peaks at the higher 2θ side. This is reflected by the differences of higher-2θ vs. lower-2θ peak ratios, i.e., 22.4 for 200° C. sample and 4.8 for 400° C. sample. That means that there is a lower degree of lattice strain for the 400° C. sample. Also, there is clear difference of the two samples by comparison of the relative (111)/(200) peak intensities. The (111)/(200) peak is 2.18 for 200 C and 1.82 for 400 C. The 400° C. sample exposes apparently more (200) crystal planes than the 200° C. sample. DFT calculation result has shown that hydrogen has a stronger adsorption energy on Ag (200) than Ag (111). The enhanced adsorption energy improves the intrinsic catalytic activity (ΔG(H*)=0.6344 and 0.2751 eV for Ag(111) and (200), respectively). Therefore, it is the combination of the Ag paste formulation parameters and the thermochemical treatment parameters that allowed the control of the directional growth of the (200) surface, the atomic coordination, and the lattice strain. The lower atomic coordination number and a certain degree of lattice strain are responsible for the improvement of the hydrogen adsorption.

Also, the domain sizes were calculated based on the peak width (Dp=(0.94×λ)/(3 Cos θ), where X ray wavelength=0.15418, Dp=Average Crystallite size, β=Line broadening in radians, θ=Bragg angle, λ=X-Ray wavelength. Based on peak position (2θ)=38.3006; and FWHM ((2θ)=0.28; Dp=31.38 nm for 200 C treated Ag. Based on peak position (2θ)=38.3164; FWHM ((2θ)=0.23, Dp=38.21 nm 200 degree Celsius treated silver (Ag).

### Electrochemical HER Activity

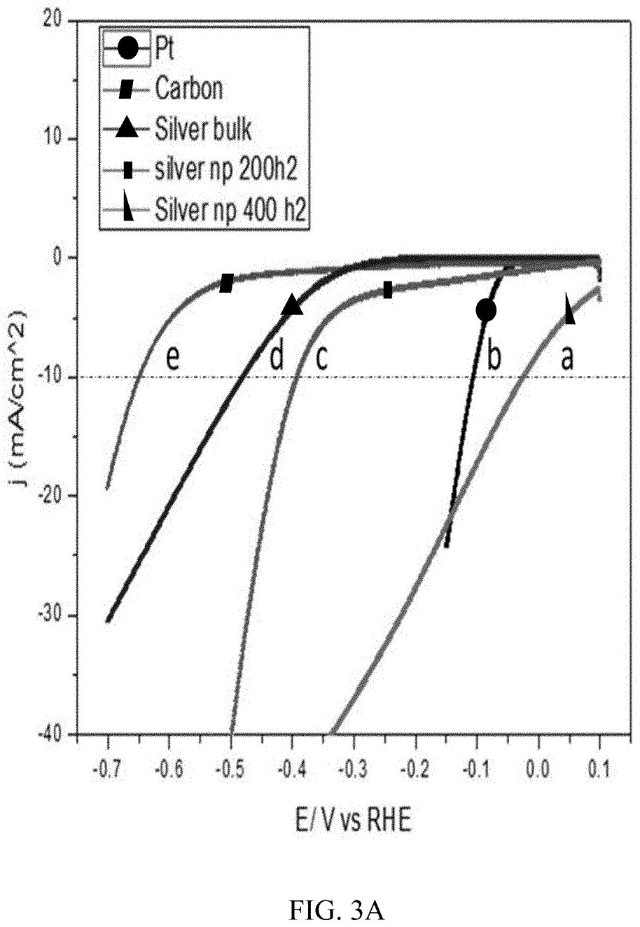

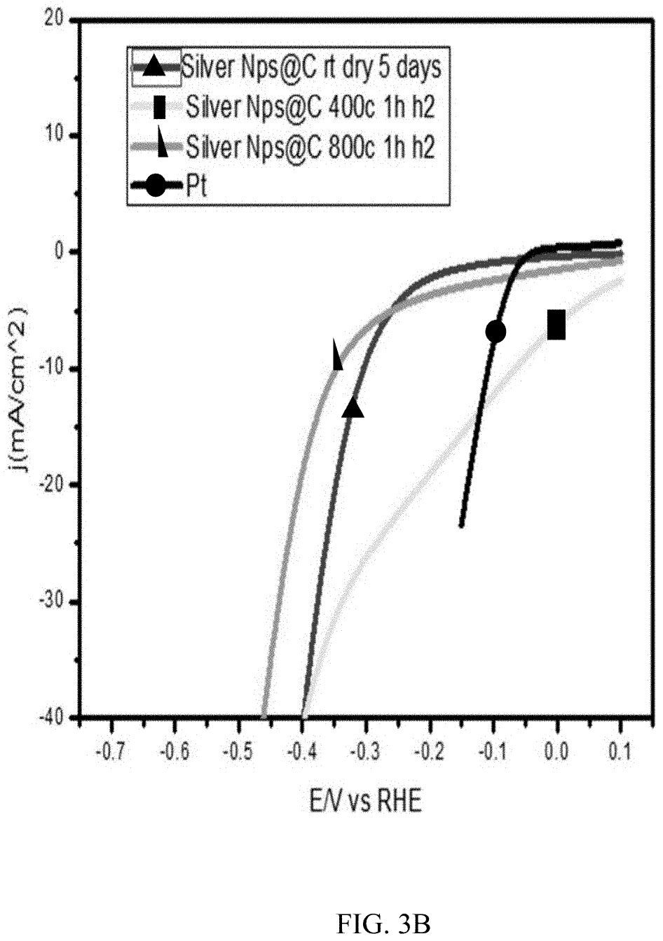

FIGS. 3A and 3B depict hydrogen evolution reaction properties of different temperature hydrogen (H₂) treated silver (Ag) paste which were tested in a standard three-electrode system calibrated with a reversible hydrogen electrode. For comparison, commercial platinum (Pt) bulk, silver (Ag) bulk and carbon (C) support were assessed under the same conditions. As shown in FIGS. 3A and 3B, the result reveal that 400° C. H₂ treated silver (Ag) paste exhibit the best HER performance among the five samples, with the lowest overpotential 30 mV at 10 mV cm⁻².

Table 1 lists some of the recent examples of studies in developing effective silver (Ag) relative catalysts for HER. These catalysts are compared in terms of the electrocatalytic performance under same reaction conditions. Based on the values of the overpotentials, catalyst embodiments of the present disclosure exhibit the lowest overpotential, thus showing the highest activity for water splitting.

TABLE 1
HER activity comparison or catalysts in this work with
previously reported ones.

| Catalysts | Electrolyte | η₁₀ (mV) | Ref. |
|---|---|---|---|
| Ag paste (H₂ treated) | 0.5M | 30 | This work |
| Pt Bulk | 0.5M | 115 | This work |
| L-Ag | 0.5M | 32 | ⁷ |
| | 1M PBS | 141 | |
| | 1 NaOH | 185 | |
| 20% Pt/C | 0.5M | 35 | ⁷ |
| V-Ag-120 min | 0.5M | 362 | ⁸ |
| P-Ag @ NC | 0.5M | 78 | ⁹ |
| Ag (NPs) | 1M NaOH | 423 | This work |
| Activated Ag/MoSx | 0.5M | 120 | ¹⁰ |

In summary, the as-prepared catalyst exhibits a very high activity for water splitting in the acidic electrolyte, which is better than that the state-of-the-art and commercially-available platinum catalysts.

The entire disclosure of all applications, patents, and publications cited herein are herein incorporated by reference in their entirety. While the foregoing is directed to embodiments of the present disclosure, other and further embodiments of the disclosure may be devised without departing from the basic scope thereof.

What is claimed is:

1. An electrode material for hydrogen evolution reaction, comprising: a plurality of ultra-small polyacrylic acid (PAA) coated silver nanoparticles.

2. The electrode material for hydrogen evolution reaction of claim 1, wherein the plurality of ultra-small PAA coated silver nanoparticles have an average longest diameter of about 1.0-30 nm.

3. The electrode material for hydrogen evolution reaction of claim 1, wherein the plurality of ultra-small PAA coated silver nanoparticles are characterized as substantially mono-disperse nanoparticles have an average diameter of about 1.0-30 nm.

4. The electrode material for hydrogen evolution reaction of claim 1, wherein the plurality of ultra-small PAA coated silver nanoparticles are characterized as substantially mono-disperse nanoparticles have an average diameter of about 1.0-10 nm.

5. The electrode material for hydrogen evolution reaction of claim 1, wherein the plurality of ultra-small PAA coated silver nanoparticles are characterized as highly-efficient electrocatalysts toward hydrogen evolution reaction in acidic media.

6. The electrode material for hydrogen evolution reaction of claim 1, comprising: a plurality of particles comprising an altered crystal structure featuring a lower surface atomic coordination number, a lattice strain of about 0.5% to about 1%, and combinations thereof.

7. The electrode material for hydrogen evolution reaction of claim 1, wherein the electrode material is characterized as a catalyst.

8. The electrode material for hydrogen evolution reaction of claim 1, comprising a capping agent.

9. An electrode for hydrogen evolution reaction formed by a substrate and the electrode material according to claim 1, wherein the electrode material is provided as a coating on the substrate.

10. The electrode for hydrogen evolution reaction of claim 9, wherein the electrode is a cathode disposed within an electrochemical cell comprising an acidic electrolyte.

11. The electrode for hydrogen evolution reaction of claim 9, wherein the substrate is carbon.

12. A system for water electrolysis comprising an anode and a cathode, wherein the cathode is the electrode of claim 9.

13. A method of making a plurality of ultra-small polyacrylic acid (PAA) coated silver nanoparticles, comprising:
heating an aqueous solution including a silver source material, a reducing agent, and a capping molecule under conditions suitable for forming a reaction mixture; and
contacting the reaction mixture with an effective amount of antisolvent to form one or more PAA-coated silver nanoparticles.

14. The method of claim 13, wherein the silver source material is a silver salt.

15. The method of claim 14, wherein the silver salt is silver nitrate.

16. The method of claim 13, wherein the reducing agent is ethanolamine.

17. The method of claim 13, wherein silver source material is silver nitrate (AgNO₃), the reducing agent is monoethanolamine (MEA) and the capping agent is polyacrylic acid (PAA).

18. The method of claim 13, wherein the antisolvent is ethanol.

19. The method of claim 13, wherein the heating is to a temperature of about 90 degrees Celsius for a first duration in an air atmosphere.

20. A method of making an electrode, comprising:
contacting a substrate with a formulation comprising an electrode material comprising a plurality of polyacrylic acid (PAA) coated silver nanoparticles in a hydrogen atmosphere; and
heating the formulation atop the substrate to a temperature of about 150 to about 700 degrees Celsius for a duration sufficient to form an electrode for hydrogen evolution reaction, wherein the electrode material is provided as a coating on the substrate.

21. The method of claim 20, wherein the electrode material comprising a plurality of polyacrylic acid (PAA) coated silver nanoparticles is provided in an amount sufficient to form a continuous coating atop and around the electrode.

22. A conductive electrode paste or ink composition, comprising: an electrode material comprising a plurality of polyacrylic acid (PAA) coated silver nanoparticles.

23. The conductive electrode paste or ink composition of claim 22, further comprising a mixture of deionized water and ethylene glycol.
